(19) United States
(12) Patent Application Publication
(10) Pub. No.: US 2025/0296160 A1
(43) Pub. Date: Sep. 25, 2025

(54) ERGONOMIC TOOL FOR REPEATABLE TASKS

(71) Applicant: Swanstrom Tools USA Inc., Superior, WI (US)

(72) Inventor: Timothy W. Sheriff, Duluth, MN (US)

(21) Appl. No.: 19/089,718

(22) Filed: Mar. 25, 2025

Related U.S. Application Data
(60) Provisional application No. 63/569,549, filed on Mar. 25, 2024.

(51) Int. Cl. B23D 15/04; A44C 27/00; B23D 33/02; B23D 35/00

(52) U.S. Cl. CPC B23D 15/04; A44C 27/00; B23D 33/02; B23D 35/008

(57) ABSTRACT

A tool includes a base; a guide member supported by the base, the guide member defining a longitudinal axis; an actuator coupled to guide member; a coupling rod supported by the guide member and functionally coupled to the actuator, wherein the coupling rod is operable to linearly translate responsive to input from the actuator, and wherein the coupling rod includes an attachment mounting surface; a spring supported by the guide member and contacting the coupling rod, wherein the spring is configured to bias the coupling rod toward a first position and configured to resiliently deform responsive to the actuator providing input to the coupling rod; and an attachment removably coupled to the attachment mounting surface of the coupling rod, wherein the attachment linearly translates in response to linear translation of the coupling rod.

### CROSS-REFERENCE TO RELATED PATENT APPLICATIONS

The present application claims the benefit of priority to U.S. Provisional Patent Application No. 63/569,549, filed Mar. 25, 2024, the content of which is incorporated herein by reference in its entirety.

### FIELD

The present disclosure relates generally to apparatuses, systems, and methods for an ergonomic tool for mounting various attachments for repeatable tasks. More specifically, the disclosure relates to apparatuses, systems, and methods relating to a tool used to perform very precise tasks in a repeatable manner with accurate results.

### BACKGROUND

Jewelry making often includes very meticulous and fine details which requires a high level of skill to incorporate into a piece. Because the details on jewelry may be very small, certain features may require very precise tasks and materials in order to produce a piece with the fine detailing required by the design. Such designs may include, for example, granules which are used to provide design elements to a piece.

In this example, granules are typically formed by taking a small wire and cutting a very small length of the wire for the starting material (e.g., metal). Once the wire is cut into the various small segments, each segment is heated to the liquid phase, at which point the surface tension of the material results in the small segment taking the shape of a sphere. As the material cools, small granules or spheres are provided which can be incorporated into a design.

One of the difficulties of incorporating granules into a design is that it is very difficult to cut a wire at such small lengths to have a consistent amount of material for forming like sized materials. Some jewelry makers will cut many lengths of a wire into segments, heat the segments to form the granules, and then hand sort the granules into their various relative sizes in order to produce an appropriate amount of like-sized granules for a given piece. Other tasks including punching through a material may have similar difficulties.

Additionally, many tools for performing these repeatable tasks are not designed for the ease and comfort of a user. For example, same tools may require the user to manipulate the tool in a way that is not comfortable or convenient for the user.

### SUMMARY

A tool is provided that can be provided with various attachments for ergonomic and repeatable movements.
According to one example (“Example 1”), a tool includes a base; a guide member supported by the base, the guide member defining a longitudinal axis; an actuator coupled to guide member; a coupling rod supported by the guide member and functionally coupled to the actuator, wherein the coupling rod is operable to linearly translate responsive to input from the actuator, and wherein the coupling rod includes an attachment mounting surface; a spring supported by the guide member and contacting the coupling rod, wherein the spring is configured to bias the coupling rod toward a first position and configured to resiliently deform responsive to the actuator providing input to the coupling rod; and an attachment removably coupled to the attachment mounting surface of the coupling rod, wherein the attachment linearly translates in response to linear translation of the coupling rod.
According to another example (“Example 2”), further to Example 1, the actuator includes one of a cam and a pneumatic actuator.
According to another example (“Example 3”), further to Example 1, the actuator includes an axle coupled to the guide member substantially perpendicular to the longitudinal axis of the guide member, a cam coupled to the axle, and an input member coupled to the axle and configured to rotate the axle upon actuation of the input member.
According to another example (“Example 4”), further to Example 1, the coupling rod includes a contact surface, the contact surface configured to be actuated by the cam.
According to another example (“Example 5”), further to Example 1, the guide member defines a lumen, wherein the coupling rod is positioned at least partially within the lumen.
According to another example (“Example 6”), further to Example 5, the base includes an aperture positioned proximate the lumen of the guide member.
According to another example (“Example 7”), further to Example 1, the tool further includes a workpiece support member coupled to the base, wherein the workpiece support member is positioned proximate to the attachment.
According to another example (“Example 8”), further to Example 1, the base includes an interface member configured to removably couple to a surface.
According to another example (“Example 9”), further to Example 1, the tool further includes a stop member adjustably coupled to one of the guide member and the base, wherein the stop member includes a stop surface configured to limit extension of an object into the guide member beyond the stop surface.
According to another example (“Example 10”), further to Example 1, the attachment includes one of a blade, a die punch, or forming member.
According to an example (“Example 11), a cutter includes a base; a guide member supported by the base, the guide member defining a longitudinal axis; an axle extending through the guide member substantially perpendicular to the longitudinal axis of the guide member; an actuator rotatably coupled to the axle and configured to rotate relative to the guide member about an axis defined by the axle; a cam coupled to the axle and configured to rotate in response to rotation of the actuator; a blade supported by the guide member and configured to linearly translate along a blade axis parallel to the longitudinal axis in response to rotation of the cam; a wire support member supported by the base, the wire support member configured to position a wire proximate the blade; and a length stop member moveably positioned adjacent to the blade, wherein the position of the length stop member is linearly adjustable in a direction perpendicular blade axis.
According to another example (“Example 12”), further to Example 11, the cutter further includes a coupling rod supported by the guide member, the coupling rod coupled to the blade.
According to another example (“Example 13”), further to Example 12, the coupling rod includes a contact surface, wherein the cam is operable to contact the contact surface of the coupling rod.
According to another example (“Example 14”), further to Example 13, the contact surface includes a wear pad.
According to another example (“Example 15”), further to Example 12, the tool further includes a spring supported by the guide member and contacting the coupling rod, wherein the spring is configured to bias the coupling rod toward the cam.
According to another example (“Example 16”), further to Example 12, wherein the guide member defines a lumen, wherein the coupling rod is positioned at least partially within the lumen.
According to another example (“Example 17”), further to Example 16, the blade is coupled to the coupling member in the lumen of the guide member, wherein the blade is a replaceable blade.
According to another example (“Example 18”), further to Example 16, the base defines an aperture that at least partially aligns with the lumen.
According to another example (“Example 19”), further to Example 18, the cutter further including a collecting vessel, wherein the collecting vessel is supported by the base at a position at least partially aligned with the aperture and the lumen.
According to another example (“Example 20”), further to Example 11, the cutter further including a guide positioned between the blade and the wire support member, wherein the guide defines a surface configured to provide an opposing surface proximate to which the blade translates during a stroke.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a front view of a tool in accordance with an embodiment;

FIG. 2 is a rear view of the tool of FIG. 1;

FIG. 3 is a side view of the tool of FIG. 1;

FIG. 4A is a view of an actuator of a tool in accordance with an embodiment;

FIG. 4B is a view of the actuator of FIG. 4A after actuation of the actuator;

FIG. 5A is a view of an actuator of a tool in accordance with an embodiment;

FIG. 5B is a view of the actuator of FIG. 5A after actuation of the actuator;

FIG. 6A is a view of an attachment of a tool in accordance with an embodiment;

FIG. 6B is a view of the attachment of FIG. 6A after actuation of the actuator;

FIG. 7 is a bottom view of a tool showing apertures through a base portion, in accordance with an embodiment;

FIG. 8 is a schematic view of a tool in accordance with an embodiment;

FIG. 9 is a schematic view of a tool with a cutter attachment coupled thereto, in accordance with an embodiment;

FIG. 10 is a schematic view of a workpiece support member, in accordance with an embodiment;

FIG. 11 is a schematic view of a tool with a punch attachment coupled thereto, in accordance with an embodiment;

FIG. 12 is a schematic view of a tool with a forming attachment coupled thereto, in accordance with an embodiment; and

FIG. 13 is a schematic view of a tool implementing a hydraulic actuator in accordance with an embodiment.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

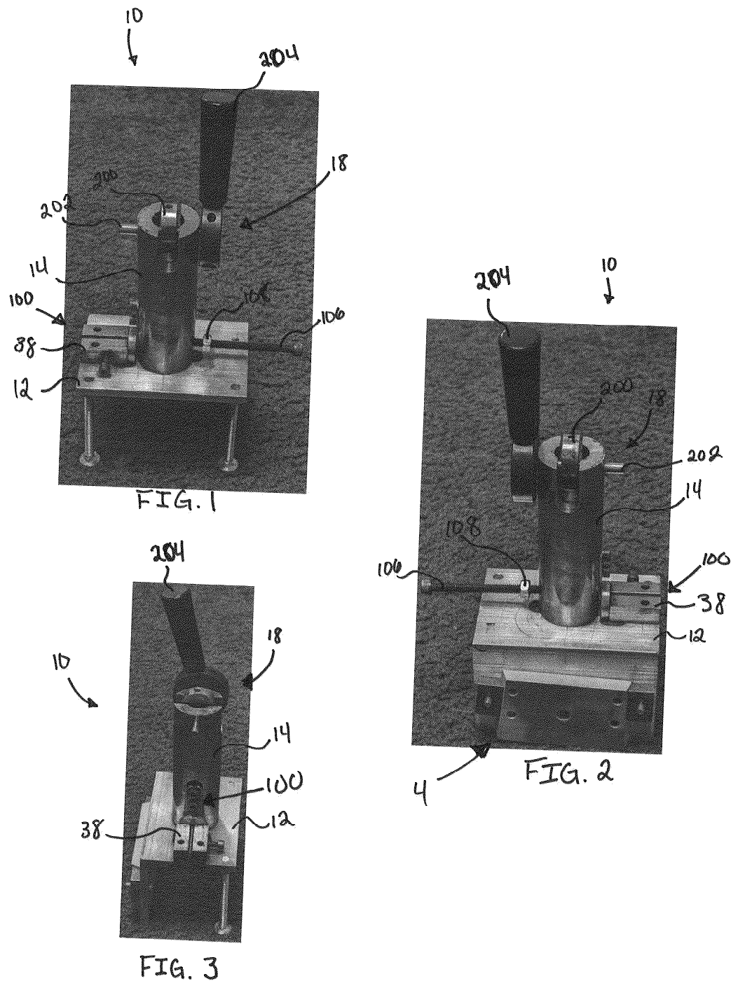

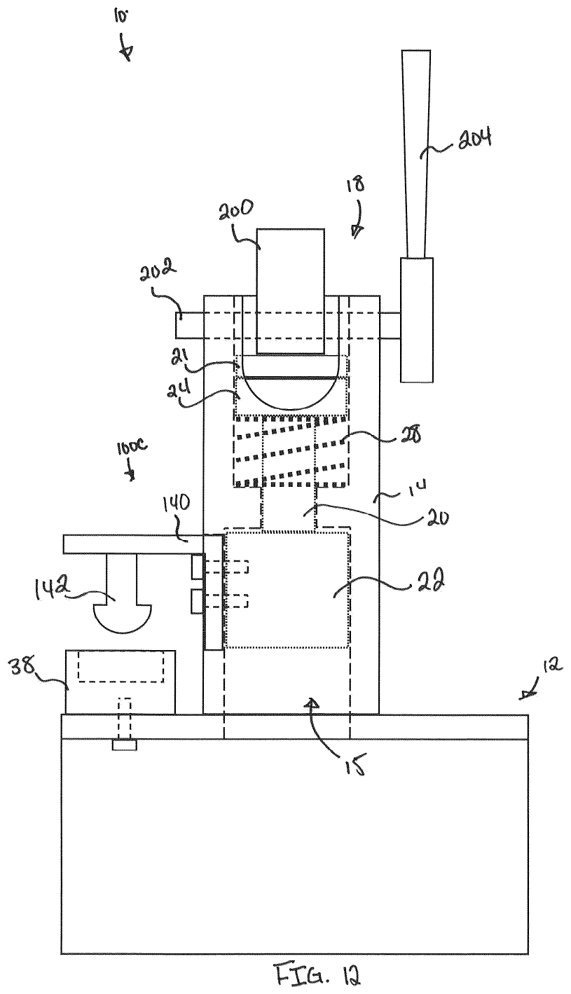

The tool shown in FIG. 1 is provided as an example of the various features of the device and, although the combination of those illustrated features is clearly within the scope of invention, that example and its illustration is not meant to suggest the inventive concepts provided herein are limited from fewer features, additional features, or alternative features to one or more of those features shown in FIG. 11. For example, in various embodiments, the workpiece support member of the device shown in FIG. 1 may include the features described with reference to FIG. 10. It should also be understood that the reverse is true as well.

Referring to FIGS. 1-3, a tool 10 is illustrated that can be utilized with various attachments to perform different tasks. The tool 10 has components that can be easily switched out to provide different functionalities while implementing generally the same actuation. Actuation of the tool will be described in more detail and with various methods of and means for actuation that are all within the scope of the disclosure. The tool 10 can be mounted in various ways to various surfaces. For example, the tool 10 includes a base 12 that can be mounted to a surface via a clamp, permanent or semi-permanent coupling, removable dovetail, and so forth. The base 12 may also be placed on a surface and used unmounted. The base 12 supports the remaining components of the tool 10.

The tool 10 further includes a guide member 14 that is supported by the base 12. The guide member 14 facilitates or provides the structure or support by which the other features and components may operate during use. The guide member 14 may include various forms and shapes and those shown are not to be considered limiting to the extent that other forms or shapes could be implemented in the spirit of the disclosure provided herein. The guide member 14 and the base 12 are coupled together (e.g., via a removable or permanent coupling) or may be formed as an integral component. The guide member 14 defines a longitudinal axis 16 which is described and referenced herein in more detail (see FIG. 8).

Referring to FIG. 8-13 in addition to FIGS. 1-3, the tool 10 further includes an actuator 18 that is coupled to the guide member 14. The actuator 18 can be provided in various forms that can be used manually (e.g., handles) or may be automated (e.g., motorized). A few specific examples of actuators 18 are discussed hereafter in more detail. The actuator 18 is provided as an input to facilitate the function of the device. For example, when an attachment 100 is coupled (e.g., either directly or indirectly) to the actuator 18, the actuator 18 is capable of providing the input (e.g., movement or force) required to actuate the attachment 100 for its intended purpose. In some embodiments, the attachment 100 may be coupled to the actuator 18 via a coupling rod 20 or coupling member. The coupling rod 20 is supported by the guide member 14. In some embodiments, the coupling rod 20 extends through at least a portion of the guide member 14. For example, the guide member 14 may include a lumen 15 defined thereby, the lumen 15 extending at least partially along the length of the guide member 14. In some embodiments, the lumen 15 extends from the first end to the second end of the guide member 14 such that the guide member 14 is open on each of its ends. In some embodiments, the actuator 18 and the coupling rod 20 are coupled proximate a first end of the guide member 14 next to or within the lumen 15 and the coupling member extends through at least a portion of the lumen 15 toward the second end of the guide member 14. As the actuator 18 is actuated, the motion of the actuator is translated to the coupling rod 20. In some embodiments, the coupling rod 20 is operable to translate the motion of the actuator 18 into linear movement. For example, the coupling rod 20 may act similar to a piston such that the head 22 of the coupling rod 20 moves linearly within the lumen 15 as constrained by the guide member 14. The coupling rod 20 is functionally coupled to the actuator such that the coupling rod 20 (specifically the head 22) is operable to linearly translate responsive to input from the actuator 18. The coupling rod 20 (e.g., the head 22) includes an attachment mounting surface 26 which allows various attachments 100 to be mounted (e.g., removably mounted) to the head 22 and thus be actuated in unison with the actuator 18. The attachment mounting surface 26 can accommodate or be provided to accommodate various couplings, including, but not limited to, fasteners, tracks, adhesives, friction fits, and so forth.

In some embodiments, a spring 28 is supported by the guide member 14 and contacts a portion 24 of the coupling rod 20. The spring 28 is configured to bias the coupling rod 20 toward a neutral position. The guide member 14 may include recesses, reliefs, and stops which facilitate compression and expansion of the spring 28 as the actuator 18 is cycled. For example, the guide member 14 may define a surface 30 within the lumen 15 against which one end of the spring 28 is positioned. The other end of the spring 28 is positioned against a portion 24 of the coupling rod 20 such that during actuation, the spring 28 compresses as the coupling rod 20 translates in response to actuation of the actuator 18 and the spring 28 expands as input is no longer applied in order to return the coupling rod 20 to the neutral position. Stated otherwise, the spring 28 is supported by the guide member 14 and contacts the coupling rod 20 such that the spring 28 is configured to bias the coupling rod 20 toward a first position and configured to resiliently deform responsive to the actuator 18 providing input to the coupling rod 20.

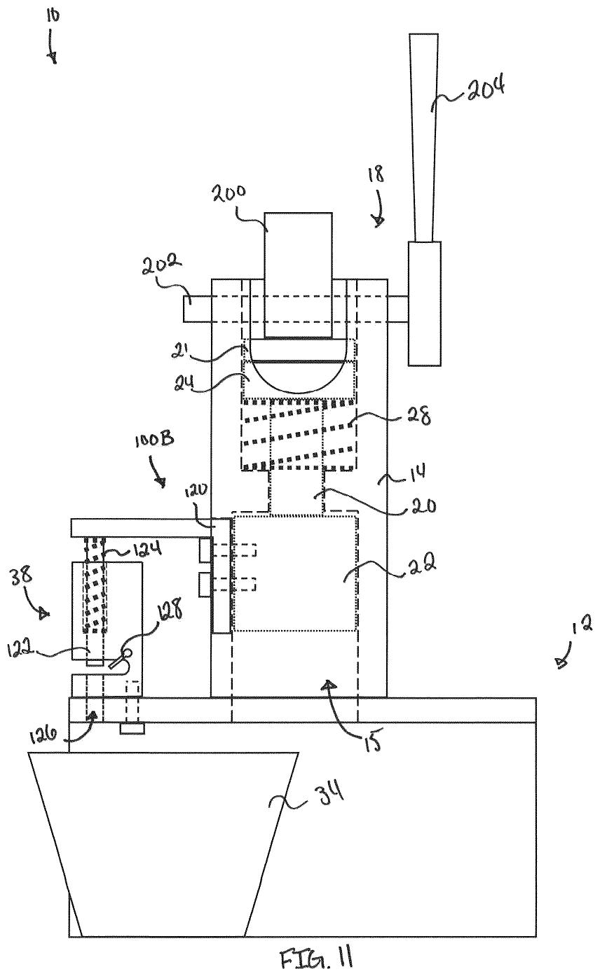

The tool 10 further includes an attachment 100 removably coupled to the attachment mounting surface 26 of the coupling rod 20. The attachment 100 linearly translates in response to linear translation of the coupling rod 20 (e.g., via actuation of the actuator 18. Various attachment may be implemented and it is understood that a user may implement a number of attachments with the tool 10 in accordance with this disclosure. One example of an attachment includes a cutter 100A (see FIG. 9). A cutter 100A may be implemented to cut objects in a consistent, repeatable manner. For example, the cutter 100A may include a blade 102 mounted to the attachment mounting surface 26. The blade 102 is actuated linearly which allows for consistent cuts of a material. The blade 102 may be provided in a V-shape or with a notch. More discussion of the various attachments 100 are discussed hereafter in greater details.

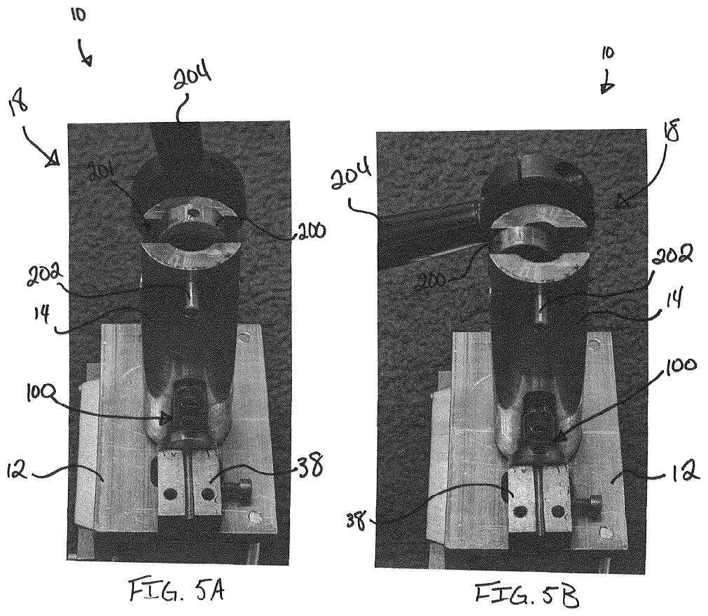

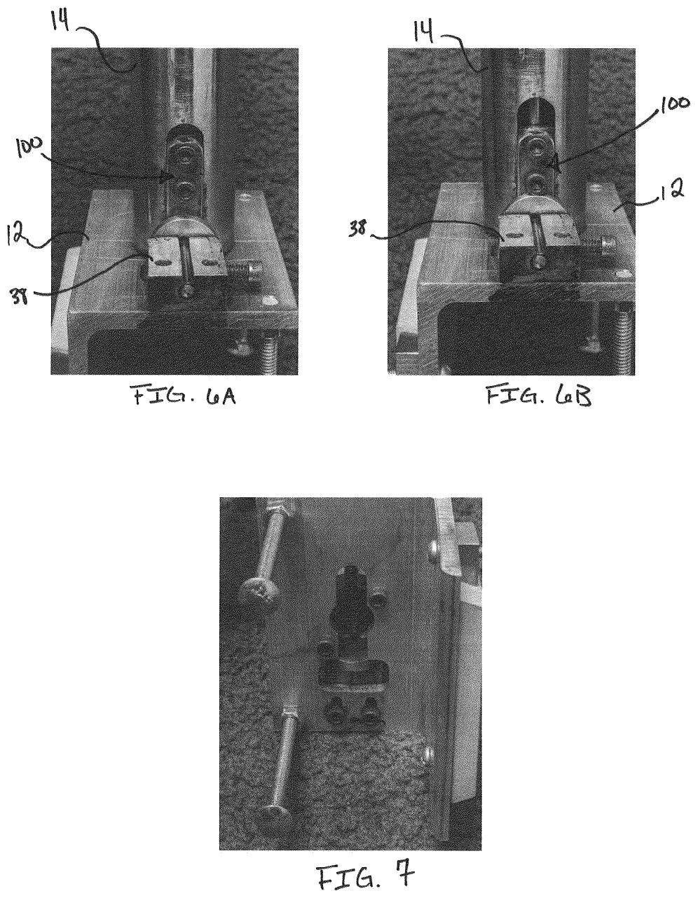

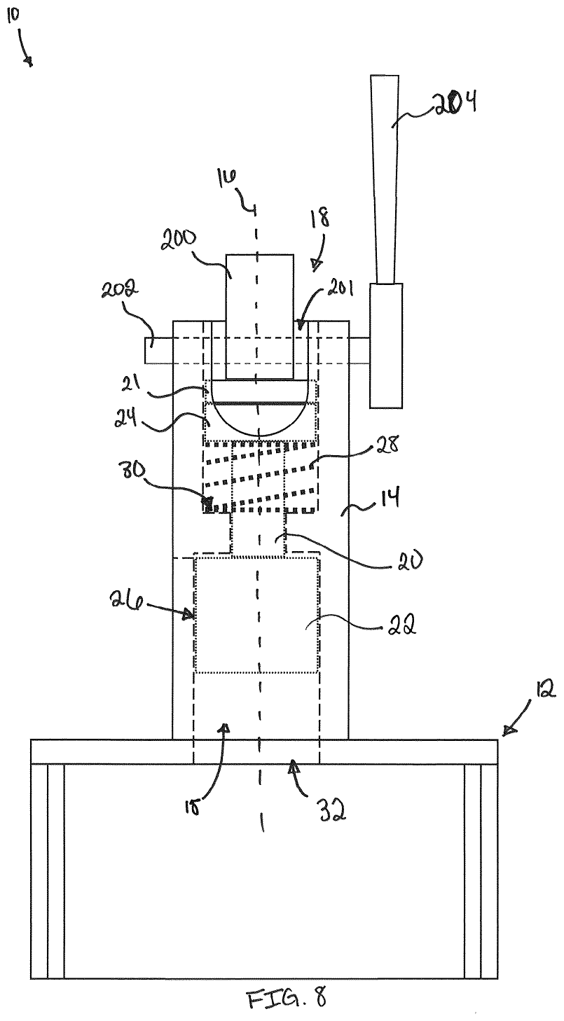

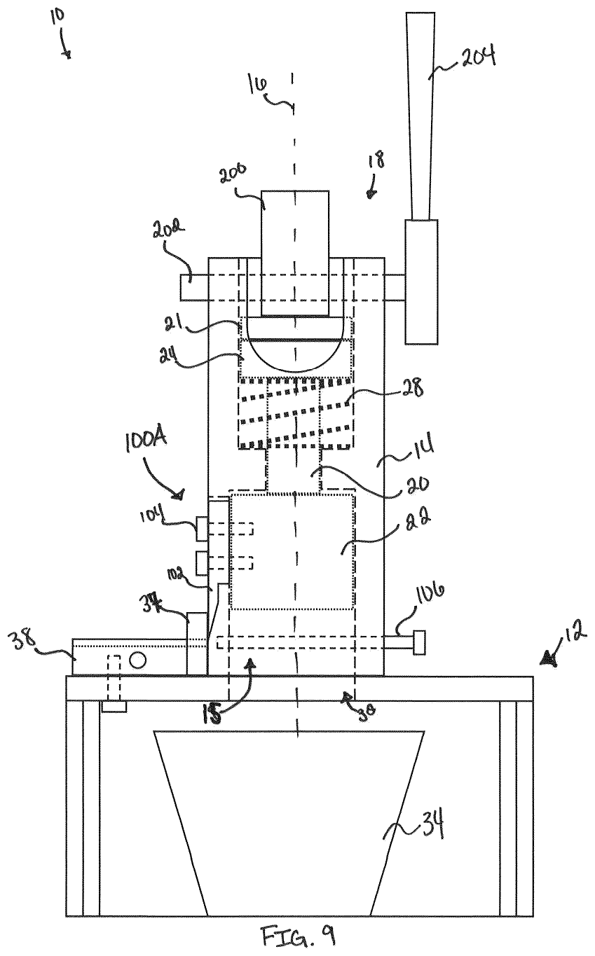

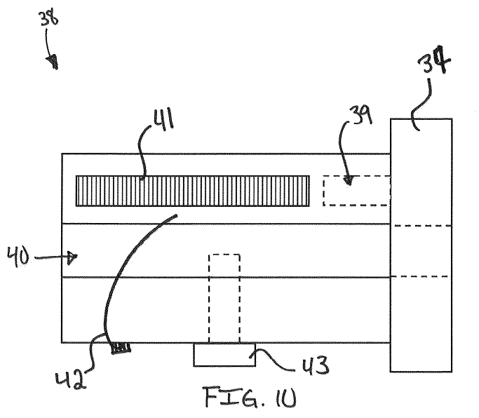

Referring more specifically to the actuator 18, various components may be implemented within the scope of this disclosure. For example, as illustrated in FIGS. 4A-5B and 8, in some embodiment, the actuator 18 may include a cam 200 fixedly coupled to an axle 202. The axle 202 is rotatably coupled to the guide member 14. For example, the axle 202 may be positioned through a portion of the guide member 14 such that it is substantially perpendicular to the lumen 15. As the axle 202 rotates, the cam 200 is configured to contact the coupling rod 20 in order to displace the coupling rod 20 and effectuate linear movement of the coupling rod 20. In some embodiments, a handle 204 is fixedly coupled to the axle 202. As the handle 204 is rotated, the rotation is transferred to the cam 200 via the axle 202. In some embodiments, the guide tube 14 may include features 201 such as reliefs or windows that provide sufficient space for the cam 200 to operate. In some embodiments, the coupling rod 20 includes a contact surface 21. The contact surface 21 is contacted by the cam 200. The contact surface 21 may include a wear or abrasion resistant material. The contact surface 21 may also include a material with a low coefficient of friction in order to minimize energy lost due to the cam 200 sliding across the contact surface 21 during use (e.g., a wear pad). In some embodiments, a motor (not shown) may be coupled to the axle 202, which can rotate the axle 202 and thus rotate the cam 200 and actuate the coupling rod 20. In other embodiments, the actuator 18 may include a bent axle (not shown) and the coupling rod 20 may be coupled to the bent portion of the bent axle. Similar to a piston, the coupling rod 20 may linearly translate at a head as the bent axle rotates. In some embodiments, the actuator 18 may include a lever arm (not shown) that advances the coupling rod 20 as the lever arm pivots about a pivot point.

In some embodiments, the base 12 may include or define an aperture 32 that is positioned proximate the lumen 15 of the guide member 14. The aperture 32 may allow workpieces to fall through the aperture 32 after they have been manipulated by one of the attachments 100. For example, in those embodiments in which the attachment 100 is a cutter 100A, the cutter 100A may cut a wire and the free pieces of the wire may fall through the aperture 32 once cut free from the starting material. In some embodiments, the base 12 may include a receptacle 34 and/or an interface (not shown) for positioning a receptacle 34 proximate the aperture 32. Thus, the receptacle 34 may receive workpieces through the aperture 32 as the tool 10 is being utilized.

In some embodiments, the tool 10 includes a workpiece support member 38 that is positioned proximate to the attachment 100 or the attachment mounting surface 26. For example, the workpiece support member 38 may be positioned proximate the attachment 100 and coupled to (e.g., removably coupled) to the base 12. Referring to FIG. 10, the workpiece support member 38 is configured to position and support the workpiece as it is being manipulated by the attachment 100. For example, the workpiece support member 38 may position a wire (not shown) proximate to the cutter 100A such that the cutter 100A can cut the wire without the wire moving laterally during the cutting motion (see FIG. 9). For example, the workpiece support member 38 may define a trough 40 such that the wire is contained at a specific position. The workpiece support member 38 may include additional features such as a retainer 42 extending therefrom and configured to otherwise confine the workpiece to a position. For example, the retainer 42 may include an adjustable clip that can be positioned to retain the workpiece in the trough 40. In another example, the retainer 42 may include a cylinder through which the wire extends. In some embodiments, the workpiece support member includes a measuring member or scale 41 to determine the length of the pieces being manipulated. This may be implemented with a rod and a length stop (discussed hereafter) to determine and set a length of the pieces of wire produced after a cut. In some embodiments, the workpiece support member may include various fasteners 43 to fasten the workpiece support member 38 to the base 12 or other components to the workpiece support member 38. Referring to FIG. 10, the workpiece support member 38 further includes a wire guide 37 that defines a lumen through which a wire may pass for access to the cutter 100A (see FIG. 9). The wire guide 37 also provides a surface against which the cutter 100A may operate. The wire guide 37 may be coupled to the body of the workpiece support member 38 via a spring plunger 39. It is understood that various workpiece support members 38 may be implemented for the various types of workpieces in combination with the specific attachment 100 that is being implemented.

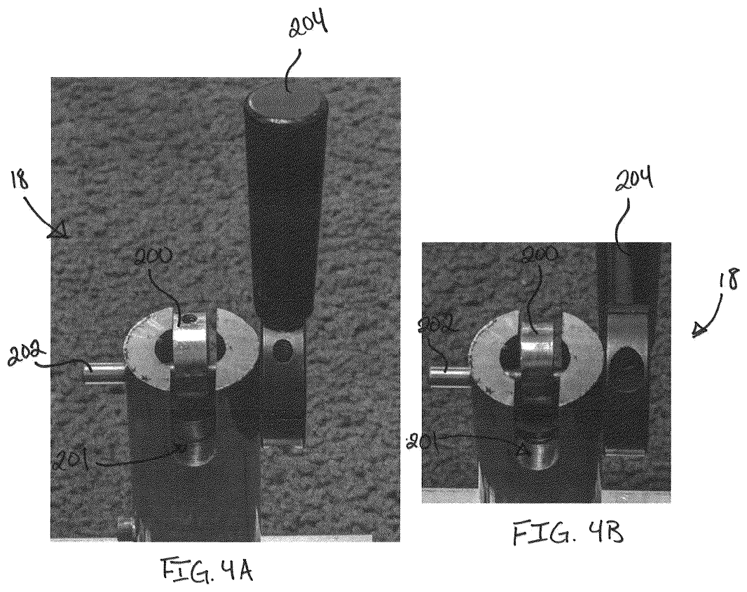

Referring to FIG. 2, in some embodiments, the base 12 includes an interface member 4 configured to removably couple to a surface. For example, the interface member 4 may include fasteners that can be fastened to a corresponding structure on a surface (e.g., bolts that can be bolted to a table), clamps that can be used to clamp to a surface, a dovetail or other coupling that can interface with a corresponding guide or rail, and so forth. On some embodiments, the base 12 is configured to be positioned on a table or other surface without being fastened or secured to the table and is still operable.

Referring more specifically to the various attachments that may be implemented, a more detailed discussion of FIGS. 9-12 are provided. Referring first to FIG. 9, in one embodiment the attachment 100 includes a cutter 100A. In this embodiment, the tool 10 may include the features previously discussed including the blade 102. The blade 102 is removably coupled to the head 22 of the coupling rod 20 (e.g., via fasteners 104). The blade 102 is configured to translate in a direction substantially parallel to the longitudinal axis 16. The blade 102 is positioned against the workpiece support member 38 (e.g., the wire guide 37) and slides along the surface during an actuation of the tool 10. The tool 10 may include a stop member 106 that can provide a surface against which a wire or workpiece may be abutted to provide a consistent length. The stop member 106 may be advanced or retracted toward the blade 102 to provide adjustable lengths of wire that are cut. For example, the stop member 106 is adjustably coupled to one of the guide member 14 and the base 12, wherein the stop member 106 includes a stop surface configured to limit extension of an object into the guide member 14 beyond the stop surface. Additionally the stop member 106 may be locked into place (e.g., via a nut 108, see FIG. 1). As lengths of a workpiece are cut, the receptacle 34 may be positioned beneath the base 12 to receive the cut pieces (e.g., through the lumen 15 and aperture 32).

Referring to FIG. 11 another attachment 100 is illustrated with the tool 10. The attachment 100 is a punch 100B that is capable of punching material. For example, the punch 100B includes a coupling member 120 that removably couples to the head 22 of the coupling rod 20. The coupling member is coupled to or integral with a punch member 122 that is configured to translate as the actuator 18 is actuated. The workpiece support member 38 may be provided in a form that is configured to support at least a portion of the punch member 122. For example, in some embodiments, the workpiece support member supports a spring 124 that engages the coupling member 120 to bias the punch member 122 toward a neutral position. The workpiece support member 38 may further include appropriate apertures 126 through which components may extend and which allows removal of the material after it is manipulated by the punch 100B. For example, the workpiece support member 38 may be a die corresponding to the punch member 122. The workpiece support member 38 may also include additional components such as a stripper 128 that can remove coatings (e.g., polymer insulators) from a wire during use or hold the workpiece in position as the tool is operated. The punched material or slugs may be collected in a receptacle 34. Various shapes and sizes of punch members 122 and dies may be implemented with the tool 10 as is consistent with the spirit of this disclosure.

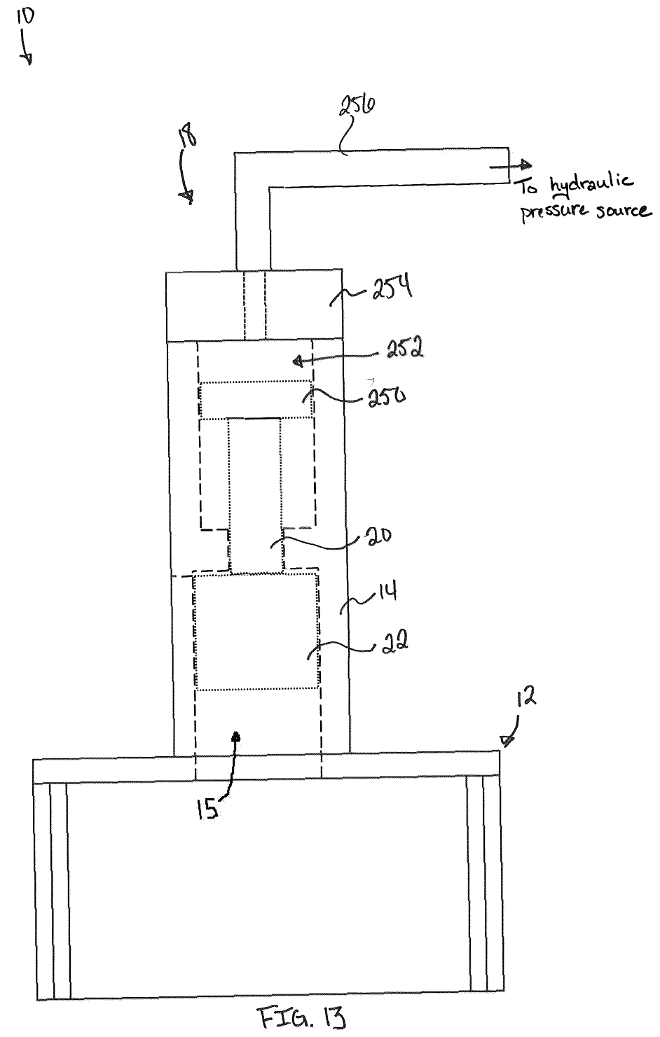

Referring to FIG. 12, the attachment 100 may include a forming tool 100C that can be removably coupled to the head 22 of the coupling rod 20. The forming tool 100C may include a tool holder 140 that is removably coupled to the head 22 of the coupling rod 20 and may be outfitted with a variety of other tools. For example as shown in FIG. 12, a forming head 142 is coupled to the tool holder 140. The forming head 142 may be provided in various shapes, sizes, and materials suited for the purposes for which they are being implemented. Other tools may also be implemented other than just forming heads, and the disclosure is not meant to be unduly limited. The forming head 142 is configured to move with the head 22 of the coupling rod 20 as the actuator 18 is actuated. The forming tool 100C may be provided with a workpiece support member 38 in the form of a containment cup (e.g., urethane cup), which allows the forming head 142 to press the workpiece into the containment cup. In other embodiments, a die may be implemented as the workpiece support member 38 to facilitate forming of the workpiece to a predefined shape.

Turning to a discussion of FIG. 13, another tool 10 is shown with an actuator 18 that operates via hydraulic or pneumatic pressure. For example, the tool 10 may be provided substantially as discussed previously including the guide member 14, base 12, coupling rod 20, and head 22 with the addition of an actuator 18 that is hydraulic. The coupling rod 20 is provided with a piston member 250 that is configured to define a boundary of a space 252 defined within the lumen 15. The other boundaries of the space 252 include a cap 254 of the actuator 18 and the walls of the guide member 14. The space 252 is configured to contain a fluid. As a fluid is provided to the space 252, the coupling rod 20 is translated to accommodate the greater volume of space needed for the fluid. As fluid is removed from the space 252, the pressure within the space actuates or translates the coupling rod 20. Thus, the position of the coupling rod 20 and consequently the attachment 100 can be modified via a hydraulic system. The tool 10 may be provided with a hydraulic pressure source (not shown) or may be implemented with a variety of hydraulic pressure sources. The hydraulic pressure source may be directly coupled to the guide member 14 or may be fluidically coupled via hydraulic lines 256. §

It will be understood that other tools may be implemented on the platform discussed herein. The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A tool comprising;
a base;
a guide member supported by the base, the guide member defining a longitudinal axis;
an actuator coupled to guide member;
a coupling rod supported by the guide member and functionally coupled to the actuator, wherein the coupling rod is operable to linearly translate responsive to input from the actuator, and wherein the coupling rod includes an attachment mounting surface;
a spring supported by the guide member and contacting the coupling rod, wherein the spring is configured to bias the coupling rod toward a first position and configured to resiliently deform responsive to the actuator providing input to the coupling rod; and
an attachment removably coupled to the attachment mounting surface of the coupling rod, wherein the attachment linearly translates in response to linear translation of the coupling rod.

2. The tool of claim 1, wherein the actuator includes one of a cam and a pneumatic actuator.

3. The tool of claim 1, wherein the actuator includes an axle coupled to the guide member substantially perpendicular to the longitudinal axis of the guide member, a cam coupled to the axle, and an input member coupled to the axle and configured to rotate the axle upon actuation of the input member.

4. The tool of claim 3, wherein the coupling rod includes a contact surface, the contact surface configured to be actuated by the cam.

5. The tool of claim 1, wherein the guide member defines a lumen, wherein the coupling rod is positioned at least partially within the lumen.

6. The tool of claim 5, wherein the base includes an aperture positioned proximate the lumen of the guide member.

7. The tool of claim 1, further comprising a workpiece support member coupled to the base, wherein the workpiece support member is positioned proximate to the attachment.

8. The tool of claim 1, wherein the base includes an interface member configured to removably couple to a surface.

9. The tool of claim 1, further comprising a stop member adjustably coupled to one of the guide member and the base, wherein the stop member includes a stop surface configured to limit extension of an object into the guide member beyond the stop surface.

10. The tool of claim 1, wherein the attachment includes one of a blade, a die punch, or forming member.

11. A cutter comprising:
a base;
a guide member supported by the base, the guide member defining a longitudinal axis;
an axle extending through the guide member substantially perpendicular to the longitudinal axis of the guide member;
an actuator rotatably coupled to the axle and configured to rotate relative to the guide member about an axis defined by the axle;
a cam coupled to the axle and configured to rotate in response to rotation of the actuator;
a blade supported by the guide member and configured to linearly translate along a blade axis parallel to the longitudinal axis in response to rotation of the cam;
a wire support member supported by the base, the wire support member configured to position a wire proximate the blade; and
a length stop member moveably positioned adjacent to the blade, wherein the position of the length stop member is linearly adjustable in a direction perpendicular blade axis.

12. The cutter of claim 11, further comprising a coupling rod supported by the guide member, the coupling rod coupled to the blade.

13. The cutter of claim 12, wherein the coupling rod includes a contact surface, wherein the cam is operable to contact the contact surface of the coupling rod.

14. The cutter of claim 13, wherein the contact surface includes a wear pad.

15. The cutter of claim 12, further comprising a spring supported by the guide member and contacting the coupling rod, wherein the spring is configured to bias the coupling rod toward the cam.

16. The cutter of claim 12, wherein the guide member defines a lumen, wherein the coupling rod is positioned at least partially within the lumen.

17. The cutter of claim 16, wherein the blade is coupled to the coupling member in the lumen of the guide member, wherein the blade is a replaceable blade.

18. The cutter of claim 16, wherein the base defines an aperture that at least partially aligns with the lumen.

19. The cutter of claim 18, further comprising a collecting vessel, wherein the collecting vessel is supported by the base at a position at least partially aligned with the aperture and the lumen.

20. The cutter of claim 11, further comprising a guide positioned between the blade and the wire support member, wherein the guide defines a surface configured to provide an opposing surface proximate to which the blade translates during a stroke.
